(19) United States
(12) Patent Application Publication
(10) Pub. No.: US 2008/0064430 A1
(43) Pub. Date: Mar. 13, 2008

(54) MOBILE COMMUNICATIONS TERMINAL AND METHOD THEREFOR

(76) Inventors: Christian Kraft, Frederiksberg C (DK); Peter Dam Nielsen, Lyngby (DK)

Correspondence Address: PERMAN & GREEN, 425 POST ROAD, FAIRFIELD, CT, 06824, US

(21) Appl. No.: 11/530,675

(22) Filed: Sep. 11, 2006

(51) Int. Cl. H04B 7/00

(52) U.S. Cl. 455/518

(57) ABSTRACT

A method for generating a contact group is disclosed. The method includes identifying a plurality of contact items being associated with a context, defining a contact group being associated with the context, wherein the contact group includes the plurality of contact items, and generating the defined contact group. A contact group generator for performing the method and an apparatus comprising such a contact group generator is also disclosed. Further, a computer program for implementing the method is disclosed.

### TECHNICAL FIELD

The disclosed embodiments relate to a method for generating contact groups, a contact group generator, an apparatus comprising such a contact group generator, and a computer program for generating contact groups.

### BACKGROUND

Within the area of cell phones, it has been known for a while to manually create groups of phone numbers, e.g. for enabling to send a message to all the numbers of the group, or for allowing only incoming calls from the telephone numbers comprised in the group. The user then has to manually add telephone numbers or phone book items to create a group. Although this feature has been present in cell phone products for several years, it has not been widely used. This lack of use is believed to be more due to the rather complicated procedure for the user to create the groups than lack of need for the groups. Within professional digital radio communication systems, where these groups many times are vital, there has been attempts to provide automatic creation of talk groups for emergency situations. Such an approach is disclosed in WO 2005/029899 A1, where a first mobile station transmits an emergency message containing its ID and localization data and an indication that it is an emergency message. Other mobile stations then transmits their Ids and localization data in response to the emergency message. A talk group is then created by selecting mobile stations which transmitted their Ids and localization data, which are within a predefined distance from the initiating mobile station. However, this is a specialized and complex system requiring highly dedicated mobile stations, and the solution will not gain an average cell phone user. Therefore, there is a need for improvements in usability of groups within terminals for mobile communication.

### SUMMARY

The disclosed embodiments provide a user-friendly approach to handling groups of contact items in a mobile communication apparatus.

According to a first aspect of the disclosed embodiments, there is provided a method for generating a contact group, comprising identifying a plurality of contact items being associated with a context, defining a contact group being associated with the context, wherein the contact group comprises the plurality of contact items, and generating the defined contact group. Thus, facilitated creation of contact groups is provided.

The context may comprise a conference call, wherein the contact items may comprise contact information on participants in the conference call. Thus, creation of the contact group facilitates setting up a conference call comprising the same participants next time.

The context may be that an identical message is sent to a plurality of recipients, wherein the contact items may comprise contact information on the plurality of recipients. Thus, creation of the contact group facilitates sending a group message to the same participants next time.

The context may be that a plurality of communication apparatuses have participated in a shortrange radio network simultaneously, wherein the contact items may comprise contact information related to the plurality of communication apparatuses. The criterion may be that the communication apparatuses have participated in a shortrange radio network simultaneously at least a predetermined number of times. This facilitates for example set-up of shortrange radio network with the participants next time, or provision of a contact group comprising users who attended e.g. a meeting where shortrange radio contacts were established.

The context may be that parties being in communication within a predetermined time recurrent interval, wherein the contact items may comprise contact information on the parties. Thus, creation of a contact group with most likely parties for communication is facilitated.

The context may be parties being in communication within a push-to-talk session, wherein the contact items may comprise contact information on the parties. This facilitates setting up a push-to-talk session with the parties next time.

The context may be based on communication statistics, wherein the contact items comprises contact information on communication parties complying with a predetermined statistical criteria. Thus, creation of a contact group with most likely parties for communication is facilitated.

The method may further comprise prompting a user whether to generate the defined contact group, and based on a user input, generating the defined contact group. The method may further comprise enabling the user to edit the contact group. These features improves user control of contact group generation.

The method may further comprise automatically generating the defined contact group.

The method may further comprise saving the contact group in a memory for contact information.

According to a second aspect of the disclosed embodiments, there is provided a contact group generator arranged to identify a plurality of contact items being associated with a context and to define a contact group being associated with the context, wherein the contact group comprises the identified plurality of contact items.

The contact group generator may be arranged to store the contact group in a memory for contact information.

The contact group generator may further comprise a contact group editor arranged to enable a user to edit the contact group.

The contact group generator may be arranged to automatically generate the contact group.

The contexts in question may be similar to those demonstrated for the first aspect of the invention.

According to a third aspect of the disclosed embodiments, there is provided an apparatus comprising a memory for contact information and a controller handling said contact information, wherein the controller comprises a contact group generator arranged to identify a plurality of contact items being associated with a context and to define a contact group being associated with the context, wherein the contact group comprises the identified plurality of contact items.

The contact group generator may be arranged to store the contact group in the memory for contact information.

The apparatus may further comprise a user interface, wherein the contact group generator is arranged to prompt a user whether to generate the defined contact group by an output via the user interface, to receive a user input via the user interface, and to generate the defined contact group based on the user input.

The contact group generator may further comprise a contact group editor arranged to enable a user to edit the contact group.

The contact group generator may be arranged to automatically generate the contact group.

The memory for contact information may be a phone book.

The context may be any of the contexts demonstrated for the first aspect of the invention.

According to a fourth aspect of the disclosed embodiments, there is provided a computer-readable medium having computer-executable components comprising instructions for identifying a plurality of contact items being associated with a context, defining a contact group being associated with the context, wherein the contact group comprises the plurality of contact items, and generating the defined contact group.

The computer-executable components may further comprise instructions for prompting a user whether to generate the defined contact group and, based on a user input, generating the defined contact group.

The computer-executable components may further comprise instructions for enabling the user to edit the contact group.

The computer-executable components may further comprise instructions for automatically generating the defined contact group.

The computer-executable components may further comprise instructions for saving the contact group in a memory for contact information.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other features and advantages of the present invention will appear from the following detailed disclosure, from the attached dependent claims as well as from the drawings.

### BRIEF DESCRIPTION OF THE DRAWINGS

The above, as well as additional, features and advantages of the disclosed embodiments, will be better understood through the following illustrative and non-limiting detailed description of preferred embodiments of the present invention, with reference to the appended drawings, where the same reference numerals will be used for similar elements, wherein:

FIG. 1 is a flow chart illustrating actions according to an embodiment of the present invention to automatically generate a contact group;

FIG. 2 is a flow chart illustrating actions according to an embodiment to generate a contact group upon user interaction;

FIG. 3 schematically illustrates a contact group generator;

FIG. 4 schematically illustrates an apparatus according to an embodiment; and

FIG. 5 schematically illustrates a computer-readable medium comprising computer-executable components with instructions to be executed in a device comprising a processor.

### DETAILED DESCRIPTION OF PREFERRED EMBODIMENTS

FIG. 1 is a flow chart illustrating actions according to an embodiment of the present invention to automatically generate a contact group. Contact items that may be relevant for contact group generation are identified 100. The relevant contact items are for example present in a phone book of a cell phone, a contact list in a computer or a personal digital assistant, or on a server providing the contact information. The relevancy is based on association with a context, which will be further discussed below. A preliminary contact group is defined 102 to comprise the relevant contact items, wherein the contact items of the contact group, and thus also the contact group, are associated with the context. The contact group is then automatically generated 104. It should be noted that a user can be enabled to edit the generated contact group.

The actions 100, 102, 104, which are preferably performed by a processor of e.g. a cell phone, a personal digital assistant, a computer, or a server providing contact information and contact groups to such devices. The processor is thus provided with instructions in a computer-readable format to perform the actions. The actions 100, 102, 104 can also be performed due to “hard-wired” features of the device performing them, or a combination of computer-readable instructions and hard-wired features.

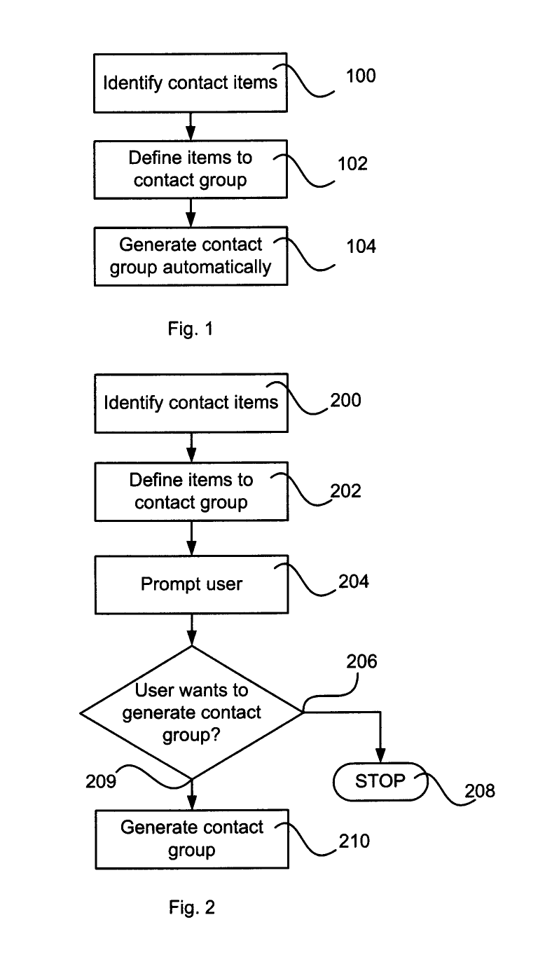

FIG. 2 is a flow chart illustrating actions according to an embodiment to generate a contact group upon user interaction. Contact items that may be relevant for contact group generation are identified 200. The relevant contact items are similar to those demonstrated for the embodiment illustrated in FIG. 1, and the relevancy is also in this embodiment based on association with a context, which will be further discussed below. A preliminary contact group is defined 202 to comprise the relevant contact items, wherein the contact items of the contact group, and thus also the contact group, are associated with the context. A user is prompted 204 about the preliminary contact group, and is enabled to confirm that the contact group be generated. If the user indicates that no 206 contact group is to be generated, the actions stop 208. If there is an confirmation 209 from the user, the contact group is generated 210. It should be noted that the user optionally can be enabled to edit the contact group, either by editing the preliminary contact group before generation 210, or by editing the generated contact group.

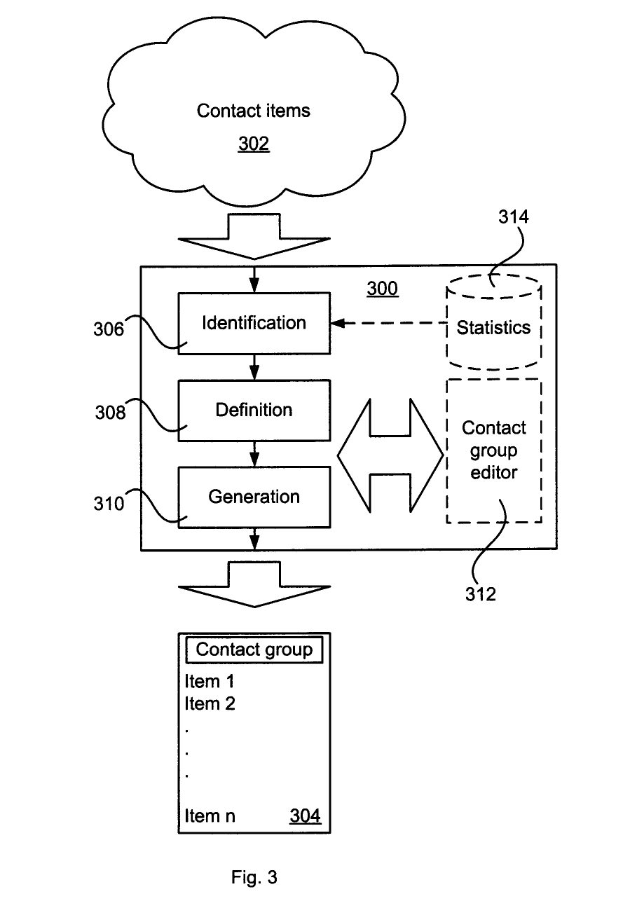

FIG. 3 schematically illustrates a contact group generator 300, which receives contact items from a contact item source 302 and provides a generated contact group 304. The contact item source can be a phone book of a cell phone, a contact list in a computer or a personal digital assistant, or on a server providing the contact information. The generated contact group can be stored in a phone book of a cell phone, a contact manager in a computer or a personal digital assistant, on a server providing the contact information services, or any other memory for contact groups or contact information.

The contact group generator 300 comprises the functional features of identification 306 of relevant contact items from the contact item source 302, definition 308 of a contact group, and generation 310 of the contact group 304. These functional features, which can be implemented in a processor provided with instructions in a computer-readable format to perform the actions, implemented by “hard-wiring” the functional features into the device performing them, or a combination of computer-readable instructions and hard-wired features.

The contact group generator 300 can optionally provide a contact group editor 312 interacting with generation 310 of the contact group, either by enabling a user to edit the defined preliminary contact group, or by enabling the user to edit the generated contact group.

The contact group generator 300 can optionally comprise a database 314 comprising statistics used for identifying relevant contact items for contact group generation. The statistics can for example comprise information on performed services and connections with communication parties, e.g. phone calls, conference calls, sent and received messages and group messages, shortrange radio network sessions, push-to-talk sessions, etc.

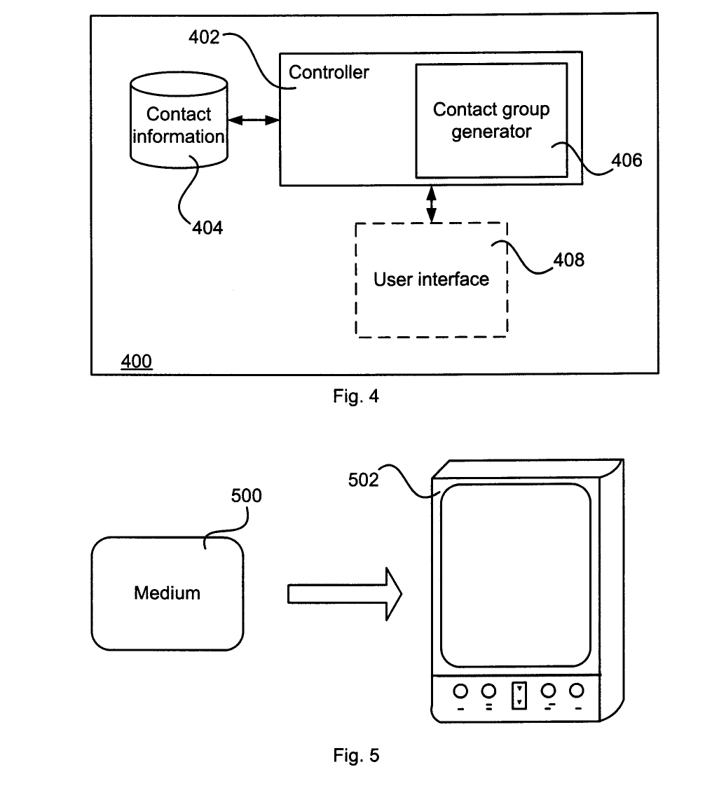

FIG. 4 schematically illustrates an apparatus 400 comprising a controller 402 and a contact information memory 404. The controller 402 is arranged for handling contact information, which is provided from the contact information memory 404, and which also can be stored in the contact information memory 404 by the controller 402. The controller comprises a contact group generator 406. The features of the contact group generator 406 are similar to those described with reference to FIG. 3. The contact group generator 406 can be arranged to interact with the contact information memory 404 directly, such as reading, storing or editing contact information. The apparatus 400 can optionally comprise a user interface 408, whereby the contact group generator 406 can prompt a user whether to generate a contact group or not, enable a user to edit a contact group, etc.

A particular example of the apparatus 400 is a cell phone, wherein the contact information memory is a phone book of the cell phone, the controller is a processor of the cell phone, and the user interface is a cell phone user interface, which normally is provided at cell phones. Other examples are that the apparatus is a personal digital assistant, a personal computer, or a contact information server.

FIG. 5 schematically illustrates a computer-readable medium 500 comprising computer-executable components with instructions to be executed in a device 502 comprising a processor. The device 502 can for example be a cell phone, a personal digital assistant, a personal computer, or a contact information server. The instructions enable the device to perform the actions discussed with reference to FIGS. 1 and 2.

With reference to FIGS. 1 to 5, contact group generation is provided by identifying contact items associated with a context. The context can be a conference call, wherein the contact items comprises contact information on participants in the conference call. The context can be that an identical message is sent to a plurality of recipients, wherein the contact items comprises contact information on the recipients. The context can be that a plurality of communication apparatuses have participated in a shortrange radio network simultaneously, wherein the contact items comprises contact information related to the participating communication apparatuses. The criterion can further be that the communication apparatuses have participated in the shortrange radio network simultaneously at least a predetermined number of times. The context can be that parties have been in communication within a predetermined time recurrent interval, wherein the contact items comprises contact information on the communicating parties. The context can be that parties have been in communication within a push-to-talk session, wherein the contact items comprises contact information on the communicating parties. The context can be based on communication statistics, wherein the contact items comprises contact information on communication parties complying with a predetermined statistical criteria, such as frequent phone calls, phone calls with a certain minimum or maximum duration, etc. The contexts can be pre-defined or user definable.

The invention has mainly been described above with reference to a few embodiments. However, as is readily appreciated by a person skilled in the art, other embodiments than the ones disclosed above are equally possible within the scope of the invention, as defined by the appended patent claims.

1. A method for generating a contact group, comprising
identifying a plurality of contact items being associated with a context;
defining a contact group being associated with the context, wherein the contact group comprises the plurality of contact items; and
generating the defined contact group.

2. The method according to claim 1, wherein the context comprises a conference call, wherein the contact items comprises contact information on participants in the conference call.

3. The method according to claim 1, wherein the context is that an identical message is sent to a plurality of recipients, wherein the contact items comprises contact information on the plurality of recipients.

4. The method according to claim 1, wherein the context is that a plurality of communication apparatuses have participated in a shortrange radio network simultaneously, wherein the contact items comprises contact information related to the plurality of communication apparatuses.

5. The method according to claim 4, wherein the communication apparatuses have participated in a shortrange radio network simultaneously at least a predetermined number of times.

6. The method according to claim 1, wherein the context is that parties being in communication within a predetermined time recurrent interval, wherein the contact items comprises contact information on the parties.

7. The method according to claim 1, wherein the context is that parties being in communication within a push-to-talk session, wherein the contact items comprises contact information on the parties.

8. The method according to claim 1, wherein the context is based on communication statistics, wherein the contact items comprises contact information on communication parties complying with a predetermined statistical criteria.

9. The method according to claim 1, further comprising
prompting a user whether to generate the defined contact group; and
based on a user input, generating the defined contact group.

10. The method according to claim 9, further comprising enabling the user to edit the contact group.

11. The method according to claim 1, further comprising automatically generating the defined contact group.

12. The method according to claim 1, further comprising saving the contact group in a memory for contact information.

13. A contact group generator arranged to identify a plurality of contact items being associated with a context and to define a contact group being associated with the context, wherein the contact group comprises the identified plurality of contact items.

14. The contact group generator according to claim 13, arranged to store the contact group in a memory for contact information.

15. The contact group generator according to claim 13, further comprising a contact group editor arranged to enable a user to edit the contact group.

16. The contact group generator according to claim 13, arranged to automatically generate the contact group.

17. The contact group generator according to claim 13, wherein the context is any of the group comprising:
a conference call, wherein the contact items comprises contact information on participants in the conference call;
an identical message is sent to a plurality of recipients, wherein the contact items comprises contact information on the plurality of recipients;
a plurality of communication apparatuses have participated in a shortrange radio network simultaneously, wherein the contact items comprises contact information related to the plurality of communication apparatuses;
a plurality of communication apparatuses have participated in a shortrange radio network simultaneously, wherein the contact items comprises contact information related to the plurality of communication apparatuses, wherein the communication apparatuses have participated in a shortrange radio network simultaneously at lease a predetermined number of times;
parties being in communication within a predetermined time recurrent interval, wherein the contact items comprises contact information on the parties; and
parties being in communication within a push-to-talk session, wherein the contact items comprises contact information on the parties.

18. The contact group generator according to claim 13, wherein the context is based on communication statistics, wherein the contact items comprises contact information on communication parties complying with a predetermined statistical criteria.

19. An apparatus comprising a memory for contact information and a controller handling said contact information, wherein the controller comprises a contact group generator arranged to identify a plurality of contact items being associated with a context and to define a contact group being associated with the context, wherein the contact group comprises the identified plurality of contact items.

20. The apparatus according to claim 19, wherein the contact group generator is arranged to store the contact group in the memory for contact information.

21. The apparatus according to claim 19, further comprising a user interface, wherein the contact group generator is arranged to prompt a user whether to generate the defined contact group by an output via the user interface, to receive a user input via the user interface, and to generate the defined contact group based on the user input.

22. The apparatus according to claim 19, wherein the contact group generator further comprises a contact group editor arranged to enable a user to edit the contact group.

23. The apparatus according to claim 19, wherein the contact group generator is arranged to automatically generate the contact group.

24. The apparatus according to claim 19, wherein the memory for contact information is a phone book.

25. The apparatus according to claim 19, wherein the context is any of the group comprising:
a conference call, wherein the contact items comprises contact information on participants in the conference call;
an identical message is sent to a plurality of recipients, wherein the contact items comprises contact information on the plurality of recipients;
a plurality of communication apparatuses have participated in a shortrange radio network simultaneously, wherein the contact items comprises contact information related to the plurality of communication apparatuses;
a plurality of communication apparatuses have participated in a shortrange radio network simultaneously, wherein the contact items comprises contact information related to the plurality of communication apparatuses, wherein the communication apparatuses have participated in a shortrange radio network simultaneously at lease a predetermined number of times;
parties being in communication within a predetermined time recurrent interval, wherein the contact items comprises contact information on the parties; and
parties being in communication within a push-to-talk session, wherein the contact items comprises contact information on the parties.

26. The apparatus according to claim 19, wherein the context is based on communication statistics, wherein the contact items comprises contact information on communication parties complying with a predetermined statistical criteria.

27. A computer-readable medium having computer-executable components comprising instructions for identifying a plurality of contact items being associated with a context;
defining a contact group being associated with the context, wherein the contact group comprises the plurality of contact items; and
generating the defined contact group.

28. The computer-readable medium according to claim 27, wherein the computer-executable components further comprises instructions for
prompting a user whether to generate the defined contact group; and
based on a user input, generating the defined contact group.

29. The computer-readable medium according to claim 27, wherein the computer-executable components further comprises instructions for enabling the user to edit the contact group.

30. The computer-readable medium according to claim 27, wherein the computer-executable components further comprises instructions for automatically generating the defined contact group.

31. The computer-readable medium according to claim 27, wherein the computer-executable components further comprises instructions for saving the contact group in a memory for contact information.
